(19) United States
(12) Patent Application Publication
(10) Pub. No.: US 2017/0132875 A1
(43) Pub. Date: May 11, 2017

(54) SYSTEMS AND METHODS FOR IMPROVING BETTING GAMES

(71) Applicant: BE THE HOUSE LTD., London (GB)

(72) Inventors: Seth FREEDMAN, London (GB); Andrew WOOLFSON, London (GB)

(21) Appl. No.: 15/405,224

(22) Filed: Jan. 12, 2017

Related U.S. Application Data
(63) Continuation of application No. PCT/EP2015/066142, filed on Jul. 15, 2015.
(60) Provisional application No. 62/025,409, filed on Jul. 16, 2014.

(51) Int. Cl. G07F 17/32; G07F 17/34

(52) U.S. Cl. CPC G07F 17/3258; G07F 17/34; G07F 17/3288; G07F 17/3209; G07F 17/323

(57) ABSTRACT

Systems and methods for improving betting games are disclosed. In particular, a new cash-out option is disclosed, which allows a game player to exit a multiple-event bet before the end of all of the events, and which allows a game maker to enjoy an additional advantage on the cash-out compared to the expected value of the bet after a certain number of events. In some embodiments, the cash-out option is offered in electronic betting games, such as electronic roulette games. In other embodiments, the cash-out option may be offered by modifying traditional betting game elements, such as roulette layouts, to include displays that display betting characteristics and cash-out options.

### CROSS-REFERENCE TO RELATED APPLICATIONS

This application is a continuation under 35 U.S.C. §120 of PCT Application No. PCT/EP2015/066142, filed Jul. 15, 2015, which claims the benefit of U.S. Provisional Patent Application No. 62/025,409, filed Jul. 16, 2014. The entire contents of each of the aforementioned applications are hereby incorporated by reference.

### BACKGROUND OF THE INVENTION

This application relates generally to wagering or betting games such as those offered by game makers in casinos and other gambling establishments.

Many different betting games are known by those of skill in the art, such as roulette, blackjack, craps, bingo, slots, and others. While these various betting games are played with different gaming instruments, such as: cards, dice, tables, wheels, and others, and with different rules, the concept of each betting game is usually that same—bet on the outcome of some event and win something if you bet correctly.

Game makers, such as casinos, are often interested in offering new or improved betting games to attract more players. Similarly, game players are typically interested in new or improved betting games to keep the play interesting. However, there are many potential issues with introducing new betting games from both a game maker's perspective and a game player's perspective.

For example, for the game maker, a new betting game may require development costs; commitment of floor space to the new game at the expense of other, known games; acquisition of new gaming instruments (e.g. tables) to play the new games; development of new rules for playing the new games; time and expense for training employees to administer the new games; and other as are known in the art. Thus, a game maker has to balance the time and costs associated with implementing a new betting game with the potential benefit of attracting new players with the new betting game.

For the game player, a new betting game may require learning new rules; studying new odds; and developing new strategies for playing the new betting game. Many players will choose to only bet on games for which they feel comfortable with well-known strategies for playing the games.

As an alternative to introducing new betting games, existing betting games can be modified. For example, lengthening the time a player plays a particular bet may increase the player's interest in the betting game due to some perceived increase in the value of the bet with respect to playing time. But lengthening the time the player plays the particular game may not be desirable to a game maker since it lengthens the rate at which the house advantage results in house profits.

Alterations to known betting games have been developed in order to allow a player to bet on the outcome of multiple events, rather than just a single event. For example, modified games of roulette allow a player to bet on the outcome of multiple events, both concurrent and sequential, rather than the traditional single spin. These modified, multi-event betting games afford players an opportunity to increase winnings by betting against worse odds for the multiple events. Unfortunately, current implementations of multiple-event betting games contain significant limitations and impediments to the player, thus creating a disincentive for players to adopt such games.

Accordingly, there is a need for improved betting games that are desirable to both the player and the game maker.

### SUMMARY

The present application discloses systems and methods for improving betting games, more particularly, systems and methods for implementing a “cash-out” option with known betting games.

In one embodiment, an electronic game system for a betting game, comprises: an electronic data store comprising computer-executable software; one or more processors configured to execute the software and cause the electronic game system to: receive a multiple-event bet from a game player; offer a cash-out option related to the multiple-event bet to the game player, wherein the cash-out option is offered after the first event and before the last event in the multiple-event bet; and receive a cash-out request from the game player.

In some instances of the electronic game, the one or more processors are further configured to cause the electronic system to: provide a multiple-event bet status to the game player.

In some instances of the electronic game, the one or more processors are further configured to cause the electronic system to: calculate the cash-out option based on at least one completed event of the multiple-event bet.

In some instances of the electronic game, the cash-out option is additionally based on game player data.

In some instances of the electronic game, the betting game is roulette.

In some instances of the electronic game, the multiple-event bet comprises receiving a bet-upon number a specific number of times in a specific number of spins.

In some instances of the electronic game, the one or more processors are further configured to cause the electronic system to: display the cash-out offer on a display device.

In another embodiment, a method for playing a betting game comprises: receiving a multiple-event bet from a game player; offering a cash-out option related to the multiple-event bet to the game player, wherein the cash-out option is offered after the first event and before the last event in the multiple-event bet; and receiving a cash-out request from the game player.

In some instances of the method, the method further comprises: providing a multiple-event bet status to the game player.

In some instances of the method, the method further comprises: calculating the cash-out option based on at least one completed event of the multiple-event bet.

In some instances of the method, the cash-out option is additionally based on game player data.

In some instances of the method, the betting game is roulette.

In some instances of the method, the multiple-event bet comprises receiving a bet-upon number a specific number of times in a specific number of spins.

In some instances of the method, the method further comprises: displaying the cash-out offer on a display device.

In yet another embodiment, a non-transitory, computer-readable medium comprises computer-executable instructions that, when executed by a processor, cause a computing device to perform a method of playing a betting game, the method comprising: receiving a multiple-event bet from a game player; offering a cash-out option related to the multiple-event bet to the game player, wherein the cash-out option is offered after the first event and before the last event in the multiple-event bet; and receiving a cash-out request from the game player.

In some instances of the non-transitory, computer-readable medium, the method further comprises: providing a multiple-event bet status to the game player.

In some instances of the non-transitory, computer-readable medium, the method further comprises: calculating the cash-out option based on at least one completed event of the multiple-event bet.

In some instances of the non-transitory, computer-readable medium, the cash-out option is additionally based on game player data.

In some instances of the non-transitory, computer-readable medium, the betting game is roulette.

In some instances of the non-transitory, computer-readable medium, the multiple-event bet comprises receiving a bet-upon number a specific number of times in a specific number of spins.

### BRIEF DESCRIPTION OF THE DRAWINGS

FIG. 1 depicts an example of the cash-out option in a simple, coin-flip betting game.

FIG. 2 depicts an electronic roulette game including a multiple-event bet option.

FIG. 3 depicts an electronic roulette game including a multiple-event bet option and a cash-out option.

FIG. 4 depicts examples of multi-chips to be used with multiple-event betting games.

FIG. 5 depicts a method for offering a cash-out option in a multiple-event betting game.

FIG. 6 depicts an example computer system, such as may be used to implement electronic betting games.

FIG. 7 depicts an electronic betting game system.

### DETAILED DESCRIPTION OF CERTAIN INVENTIVE EMBODIMENTS

Betting games pit a player's short-term hopes versus a game maker's long-term odds. Generally speaking, the lower the odds of winning a bet, the higher the payout of winning the bet, and vice-versa. And generally a “house advantage” or “house edge” is built into any particular bet to ensure that the game maker wins over the long-term. Many traditional betting games exist, and many of those can be found in casinos and the like. The rules, odds and payouts of these traditional games are well-known in the art.

### Traditional Betting Games

Traditional betting games include, for example: roulette, blackjack, craps, bingo, slots, sports betting, and others. Each betting game tends to implement the betting and the payouts individually based on the characteristics of the game. Further, most traditional betting games are single-event games, e.g., games where a player places a bet on the odds of a single event happening (e.g. picking the right number in roulette, beating the dealer's hand in blackjack, hitting the point in craps, betting on the right team in sports). As above, the odds of an event happening are inversely related to the payout if that event does happen. That is, if the event is less likely, then the payout is relatively higher. But if the event is more likely, then the payout is relatively lower. And in almost all betting games offered by game makers, such as casinos, the payouts are further reduced by a house advantage.

Roulette is a traditional betting game wherein a “croupier” or dealer spins a wheel in one direction, then spins a ball in the opposite direction around a circular track running around the circumference of the wheel. The ball eventually falls onto the wheel and into one of a plurality of pockets on the wheel, which are often colored and numbered. The resulting number pocket is the basis of many types of single-event bets offered to players of roulette (e.g. the correct number of the pocket or the correct color of the pocket). Often, a roulette player places a bet by placing money or chips or other betting instruments on a specific betting areas on a roulette table, which is known as the “layout.” Many single-event bets are possible using a traditional layout, including: “inside bets” and “outside bets.”

Examples of inside bets in roulette, which tend to have lower odds but larger payouts, include: (1) a straight (or single) bet wherein a chip is placed entirely on the middle of a number square on the layout, which pays if the ball lands in the specific pocket of the same number; (2) a split bet (i.e. a bet on two adjoining numbers) wherein a chip is placed either on the vertical or horizontal line between two numbers, which pays if the ball lands in the pocket of either of the two numbers; (3) a street bet (i.e. a bet on three numbers on a single horizontal line of the layout) wherein a chip is placed on the edge of the line of a number at the end of the line, which pays if the ball lands in the pocket any of the three numbers; (4) a corner or square bet (i.e. a bet on four numbers in a square layout) wherein a chip is placed at the horizontal and vertical intersection of the lines between the four numbers, which pays if the ball lands in the pocket any of the four numbers; (5) a six-line or double-street bet (i.e. a bet on two adjoining streets) wherein a chip is placed at the corresponding intersection between the two streets, which pays if the ball lands in the pocket any of the six numbers; (6) a trio bet (i.e. a bet on the intersecting point between 0, 1 and 2, or 0, 2 and 3 in single-zero layout roulette); (7) a basket bet (i.e. a bet on 0, 1, and 2; 0, 00, and 2; or 00, 2, and 3 (double-zero layout only) wherein the chip is placed at the intersection of the three desired numbers, which pays if the ball lands in the pocket any of the three numbers; (8) a top line bet (i.e. a bet on 0, 00, 1, 2, and 3 in double-zero layout tables) wherein a chip is placed either at the corner of 0 and 1, or the corner of 00 and 3, which pays if the ball lands in the pocket any of the numbers; and others as are known in the art.

Examples of “outside bets” in roulette, which tend to have better odds but smaller payouts, include: (1) a color bet, wherein a chip is placed on a particular (usually colored) layout area, which pays if the ball lands in a pocket of the same color; (2) an even or odd bet, wherein a chip is placed on a particular layout area (often marked with “Even” or “Odd), which pays if the ball lands in a pocket with a corresponding even or odd number; (3) a “dozen” bet, wherein a chip is placed on a particular layout area (often marked with “1-12” or “13-24” or “25-36” or “1st 12” or “2nd 12” or “3rd 12” or the like), which pays if the ball lands in a pocket with a number corresponding to a chosen “dozen;” (4) a column bet, wherein a chip is placed in a particular layout area located at the bottom a column of numbers, which pays if the ball lands in a pocket with a number corresponding to a chosen column; (5) a bottom-half bet (or “manqué” bet), wherein a chip is placed in a particular layout area (often marked with “1-18”), which pays if the ball lands in a pocket with a number within the range; (6) a top-half bet (or “passe” bet), wherein a chip is placed in a particular layout area (often marked with “19-36”), which pays if the ball lands in a pocket with a number within the range; and others as are known in the art.

Because the game maker will often pay less than the true odds that any particular single-event bet dictates, the expected value of any particular single-event bet for the player is negative i.e. the player is expected to lose money over the long-term.

Notably, roulette may be implemented on an electronic gaming system or may be hosted by a game service (such as an internet-based gaming service) in accordance with the same principles described above.

Another traditional betting game is blackjack or “twenty-one.” In blackjack, a player competes against a dealer and not against any other players. The procedure of blackjack is that a player is dealt an initial two-card hand. After receiving the initial two cards, the player has the option of taking one or more additional cards. Additionally, other options such as splitting cards or doubling down are known in the art. Ultimately, the single-event that a player bets on is beating the dealer, which can be done in several ways, including: (1) getting twenty-one points with the player's first two cards (called a blackjack), without a dealer blackjack; (2) reaching a final point total higher than the dealer without exceeding twenty-one points; or (3) letting the dealer draw additional cards until the dealer's hand exceeds twenty-one points.

Blackjack may be implemented on an electronic gaming system or may be hosted by a game service in accordance with the same principles described above.

Another traditional betting game is craps. Craps may be played by one or more players betting against a game maker, such as a casino. The players make bets on a craps table, also known as a “layout,” which displays various betting options.

Craps is normally played in two phases: “come-out” and “point.” To start a round, a shooter makes one or more come-out rolls with a pair of dice. A come-out roll of (i.e. when the sum of the dice equal) two, three, or twelve is called “craps” or “crapping out,” and anyone betting the “pass line” loses. A come-out roll of seven or eleven is called a “natural,” and anyone betting the pass line wins. The other possible numbers are the point numbers: four, five, six, eight, nine, and ten. If the shooter rolls one of these numbers on the come-out roll, this establishes the “point.” If the shooter rolls or “hits” the point value again before rolling a seven, the pass line wins and a new round starts. If the shooter rolls any seven before repeating the point number (a “seven-out”), the pass line loses and the dice pass clockwise to the next new shooter for the next round.

Like in roulette, the expected value of craps bets is usually negative, such that a player will always lose money over the long-term, because the house always sets the paid odds to below the actual odds. The only exception is the “odds bet” that the player is allowed to make after a point is established on a pass/come don't pass/don't come bet. However, this bet cannot be made independently, because the point must first be established, so the expected value of the entire bet, including odds, is still negative. Ultimately, the single-events that a craps player bets on are the values of the rolls during the different phases of the game.

Craps may be implemented on an electronic gaming system or may be hosted by a game service in accordance with the same principles described above.

Many other betting games exist and are well known in the art, such as bingo, slots, and other various card games. Like the aforementioned betting games, the bets are usually based on single-events to win. And like the aforementioned games, they may be implemented on an electronic gaming system or may be hosted by a game service.

### Multiple-Event Betting for Traditional Single-Event Betting Games

In order to make traditional betting games more appealing to players, additional multiple-event or “parlay” bets may be offered. Multiple-event bets may appeal to game players because multiple-event betting offers a myriad of different betting opportunities and potentially much higher payouts. For example, bets may be placed on a number of events happening in sequence, on a specific set of events happening within a number of events, and others. Consistent with all types of multiple-event bets, the probability of winning the multiple-event bet is reduced by the total number of events required to win the bet.

A benefit of multiple-event bet modifications to traditional betting games is that it allows a virtually unlimited number of unique bets for any traditional betting game. For example, rather than betting on a single spin of the roulette wheel, a player may bet on the outcome of two or more spins of the roulette wheel, such as two black numbers in a row or two red numbers in a row, or the like. Or a player may bet that the outcome of three spins is three even numbers, or alternatively three odd numbers, or some mix of even and odd numbers.

There are, however, many challenges associated with modifying traditional betting games to include multiple-event betting options. One challenge is modifying the layout of games like roulette and craps to provide for the additional bets. Another challenge is modifying the game rules to ensure that games still move swiftly from round to round. Yet another challenge is keeping track of the odds and payouts for the myriad different multiple-event bet options. And perhaps the biggest challenge is presenting the multiple-event bets to both casual and experienced players in a way that is understandable.

Even if a multiple-event bet is presented in such a way as to be understandable to a game player, the bet must also be desirable to the player. A potential draw of a multiple-event bet to a player is the ability to get much higher payouts for a series of events with lower overall odds. However, the player's perceived sense of control over a bet is reduced significantly when multiple events are necessary to win. While payouts for such multiple-events may be higher, they may not be high enough to cause the player to take the additional risk.

The advent of computer-based gaming (including electronic gaming devices and internet-based gaming) has increased the number of types of games that may be offered to players as well as the complexity of the types of bets, like multiple-event bets. The advantage of an electronic game over a traditional game administered by a dealer is the ability of a computer system to keep track of many types of bets from many players all at once.

In some instances, traditional betting games with dealers can be augmented with electronic gaming means, such as computers, touch-pads, hand-held electronic devices, and the like in order to enable a wider of variety of bets in a traditional gaming setting, such as a casino. For example, a roulette table could include touch-screen display devices that allow a player to place more complicated bets based on multiple events without a human dealer having to keep track of each multiple-event bet. Such electronic gaming means can further facilitate the betting process through offering electronic payment of betting funds. Accordingly, developments in computer-based gaming techniques can benefit traditional betting establishments, such as casinos.

### Cash-Out Option for Multiple-Event Bets

“Cash-out” is a feature that may improve traditional betting games implementing multiple-event betting options. In traditional multiple-event betting games, the player is stuck waiting until the end of the last event in a multiple-event sequence in order to determine a win or loss of the multiple-event bet. The cash-out feature improves the player's experience by allowing the player to exit the multiple-event bet after the first event but before the last event.

For example, a roulette player may place a multiple-event bet that each of the three next numbers will be red numbers. In return for the reduced chances of getting three red numbers in a row (as compared to getting a single red number), the player is enticed with an increased payout if all three next numbers are red. After two red numbers, the player may be both excited at the prospect of getting another red number and winning the bet, but also concerned that the next number may be black, thereby forgoing the first two positive events. Moreover, the player may be influenced by the classic “gambler's fallacy” i.e. the mistaken belief that if something happens more frequently than normal during some period, then it will happen less frequently in the future and vice versa. So here, the player may inclined to think that the odds of a third red number is actually lower than the odds of a single red number based on the fact that the preceding two numbers are red (which is wrong because the events are independent). With a traditional multiple-bet game, the player is stuck waiting for the last event. But with a cash-out option, the player may instead choose to take a reduced payout after the two positive events (here two red numbers) and forgo the risk (and potential reward) of the third and final event (the third red number).

Importantly, the cash-out option is beneficial to both the player and the game maker. For a player, cash-out allows the capitalization of positive events before the end of the multiple-event chain. And for game makers, cash-out allows a payout of less than the expected value of the multiple-event bet given the positive events. Moreover, the game maker may obtain an even higher advantage by adjusting the cash-out amount with an additional house advantage. As such, the game maker gets to exploit both the single-event advantage of the betting game and the multiple-event cash-out advantage. Thus, cash-out offers players a more interactive gameplay for multiple-event bets and game makers' a higher overall margin on any multiple-event bets.

Cash-out can be implemented in many ways. In a first implementation, a set discount rate (e.g. 10%) is applied to all cash-out options based on the expected value of the multi-event bet. For example, if the expected value of the bet at a particular stage of the multiple-event bet is $10, then the cash-out offer would be $9 (discounted by 10%). Accordingly, even though the cash-out option will change after each event in a multiple-event bet due to the changing probabilities of the remaining events, the discount rate applied to every cash-out option calculated by the game maker will remain the same.

Consider an example where a roulette player bets $10 that at least seven red numbers will occur within the next ten spins and a winning bet pays $63, and after five spins four red numbers have hit. This means that to win the overall bet, the player only needs at least three red numbers in the next five spins. There is a 47.47% chance of this happening. Thus, the expected value of the bet is $63×47.47%=$29.90. The player is offered a cash-out value, which is the expected value less a set discount rate of 10%, so the player is offered 90%×$29.90=$26.91 to cash-out. The player rejects the offer. The next spin results in a black number. Now the players needs three red numbers in the next four spins, which reduces the chances of winning the bet to 29.25%. Thus, the new expected value of the bet is $63×29.25%=$18.42. The player is again offered a cash-out less the set discount rate or 90%×$18.42=$16.59. The player accepts the cash-out and the bet is over. Notably, the player still wins money on his original bet of $10, while the casino pays less than the expected value of the bet and avoids the chance of a full payout.

In a second implementation, the discount rate may vary relative to the expected winnings. For example, if the player chooses to cash-out for less than the original bet, i.e. at a loss, the discount rate may be set lower (e.g. 2.5% discount). If, the player chooses to cash-out for a relatively small win at, the discount rate may be increased (e.g. 5% discount). Finally, if the player chooses to cash-out for a relatively large win, the discount rate may be increased even more (e.g. 10%-25% discount). For each of these options, the player perceives a benefit of locking in winnings or mitigating losses during the multiple-event bet sequence, while the game maker enjoys the benefit of paying out less than the expected value of the bet during the multiple-event bet sequence.

In a third implementation, the discount rate may be dynamically adjusted based on a player's past acceptance or rejection rate. For example, if a player is known to reject the cash-out option at all stages of a multiple-event bet, the game maker may decrease the margin on the cash-out option to further entice the player. In this way, the discount rate may be increased or decreased based on the user's past performance or behavior.

Data regarding a player's past game play (e.g. acceptance and rejection rate of cash-out options, may be collected while a player plays a multiple-event betting game. For example, in a casino, a player's choices may be associated with a player's card used during the game. In electronic and internet-based games, the player's choices may be recorded in a database and analyzed to make player-specific cash-out offers. Other means of collecting player data in both physical and electronic implementations of betting games may also be employed.

### Description of Certain Embodiments

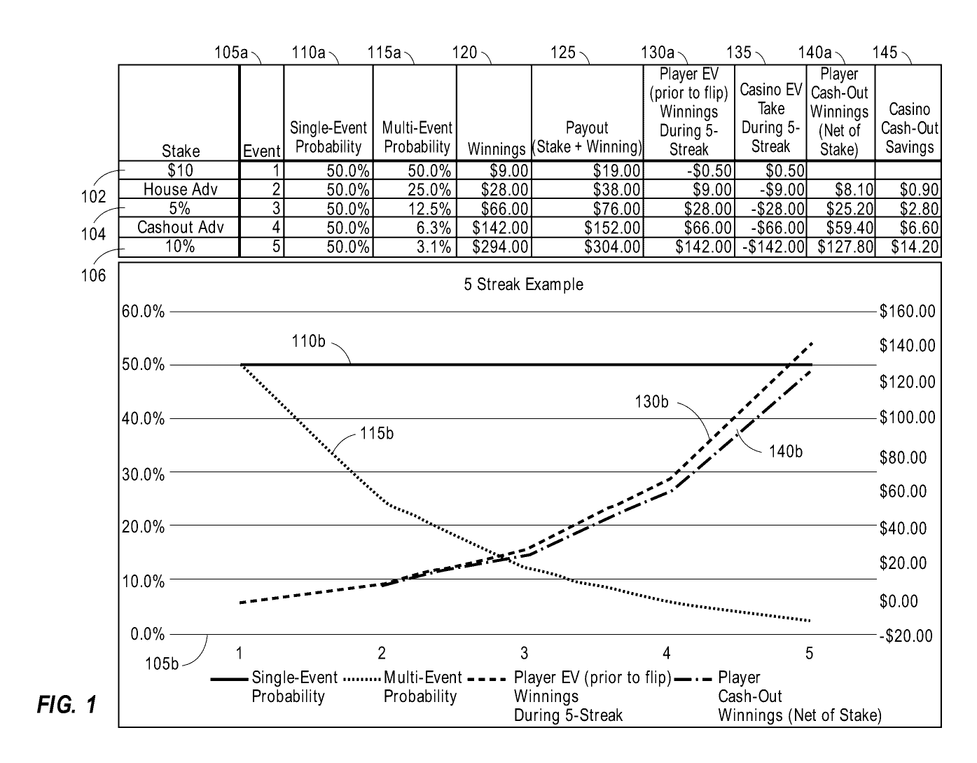

FIG. 1 depicts an example of the cash-out option in a simple, coin-flip betting game wherein a player has bet that it will get five “heads” in a row. In this particular embodiment, the stake (i.e. bet) 102 is $10. The house advantage 104 is 5%, which in this embodiment is calculated as ((probability of victory×winnings for victory)−(probability of defeat×cost of defeat))÷cost of defeat. The cash-out advantage 106 is 10% i.e. the game maker is offering the expected value of the bet less a flat 10% advantage. As discussed above, the cash-out advantage may be implemented in different ways, including flat discount rates, graduated discount rates based on payouts, and player-specific discount rates based on player-specific behavior, among others.

Column 105a (“Event”) includes five rows, each denoting a particular event in the five event bet. Column 105a corresponds with axis 105b in the chart.

Column 110a (“Single-Event Probability”) includes five rows, each denoting a single-event probability of, in this example, each individual coin flip. Here the probability of each coin flip resulting in a particular result (e.g. heads) is 50%. Column 110a corresponds to line 110b in the chart. Notably, the probability of each particular event is independent of the other events and as such, is the same.

Column 115a (“Multi-Event Probability”) includes five rows, each denoting a multiple-event probability i.e. the probability of getting a particular number of results in a row. Column 115a corresponds with line 115b on the chart. Notably, the multiple-event probability gets lower with each additional event added to chain of events necessary to win the bet. For example, the chances of betting on a first coin flip correctly are 50%. But the chances of betting on two coin flips correctly is 50%×50%=25%. As the number of events gets larger, the relative change in probabilities for each additional event in the multiple-event bet is smaller. For example, while the change from one to two events is 50%−25%=25%, the change from two to three events is 25%−12.5%=12.5%. Thus, the slops of line 115b decreases as the number of events increases.

Column 120 “Winnings” includes five rows, each denoting a winnings for getting a particular number of results in a row correct. Notably, the winnings increases as a function of (and inversely to) the multiple-event probabilities. Additionally, the winnings in column 120 reflect the effect of the “house advantage.” For example, in a fair game with no house advantage, the winnings for one event (i.e. coin flip) would be $10 and not $9. The $1 difference between the payout based solely on the odds and the payout in this example represents the house's advantage on this particular game.

Column 125 “Payout (Stake+Winning)” includes five rows, each denoting the total payout including the stake for getting a particular number of results in a row correct. In other words, if a player bets on a single flip and wins $9 and gets the stake back, the player receives $19 total.

Column 130a (“Player Expected Value Winnings During 5-Streak”) includes five rows, each denoting the player's expected value of the multiple-event bet given positive results in each preceding flip. Column 130a corresponds to line 130b. Assuming n total events, each row i is calculated as (the probability of winning n−i remaining events×the winnings for n events)−(probability of losing any of the n−i events×the stake). For example, the second row indicates that when betting on five “heads” in a row for a total winning of $294, the expected value after one positive event (i.e. one heads flip) is $9. As can be seen in the various multiple-event player expected values, the expected value for the player (and conversely the expected cost to the game maker) increases substantially after each successful event due to the fewer remaining events necessary to win the entire multiple-event bet.

Column 135 (“House Expected Value Take During 5-Streak) includes five rows, each denoting the house's (or game maker's) expected value of the multiple-event bet given positive results (for the player) in each preceding flip. Not surprisingly, these values are the negative equivalent of the player's expected value and may be calculated the same way as the player's expected value, but with reversed probabilities. As can be seen in the various multiple-event house expected values, the expected cost for the casino increases substantially after each successful event due to the fewer remaining events necessary to win. This is one of the key reasons that cash-out is a benefit to a game maker, as is explained in more detail below.

Column 140a (“Player Cash-Out Winnings (Net of Stake))” includes five rows, each denoting the cash-out option offered to a player after a particular number of events less a cash-out advantage. Column 140a corresponds to line 140b. For example, after two positive results (e.g. two heads flips), the expected value of the five flip bet to the player is $28 and the expected cost to the casino is $28. Applying a cash-out advantage 106 of 10%, the player is offered $28×90%=$25.20. While this may seem like an advantage to the player, over the long-term, the game maker actually increases its margin due to paying the player less than the expected value of the bet at that particular stage. And this is on top of the existing house advantage 104 of 5%. Thus, both the player and the game maker benefit from the cash out-option.

Column 145 (“House Cash-Out Savings”) includes five rows, each denoting the house cash-out savings given the cash-out offered to a player after a particular number of positive events. Here again, it is clear that as more positive events happen for the player, the value of offering a cash-out with a house advantage increases.

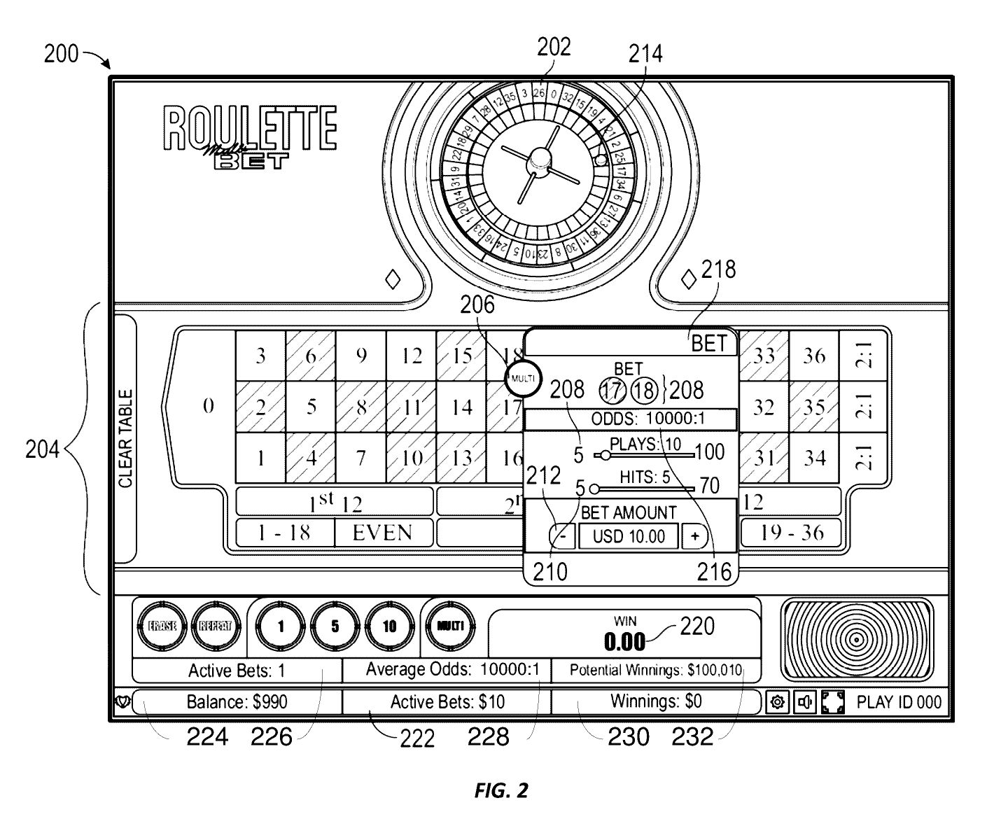

FIG. 2 depicts an electronic roulette game 200 including a multiple-event bet option. The electronic roulette game 200 can be implemented, for example, on a game-specific computer system including a display and an input device, on a mobile device including a touch-screen display (e.g. a cellular phone or a tablet device), through a web-browser on a non-game specific computer system, and the like using appropriate software and hardware.

The electronic roulette game 200 includes a roulette wheel 202, which comprises a plurality of numbered and colored pockets as is known in the art. An electronic ball 214 is shown at rest in one of the numbered and colored pockets after a spin.

Electronic roulette game 200 includes a table or “layout” 204, which comprises a plurality of numbered and colored squares as is known in the art. Additionally, the layout includes a plurality of designated bet areas e.g. (“1^{st} 12” and “1-18” and “Even”).

Electronic roulette game 200 also includes a “multiple bet chip” or “multi-chip” 206. The multi-chip 206 may be used to place bets on the table as with traditional roulette bets, but the multi-chip 206 indicates that a multiple-event bet is being placed. In an electronic version of roulette, the multi-chip 206 may only designate, for example, that a multiple-event bet has been placed, such as shown in FIG. 2. However, in other embodiments, the multi-chip may include details regarding the multiple-event bet (e.g. the number of events in the bet, or the type of bet, or the status of the bet, etc.).

A physical multi-chip may also be used in non-electronic or traditional roulette games, such as those found in a casino. In some embodiments, different physical multi-chips could be offered for different bets. For example, an “Exact 3” multi-chip could be placed on a number, or column, or line, etc., to indicate that that number, or the numbers in the column, or the numbers straddling a line, etc. will come up exactly 3 times in the next three spins. Similarly, a “3-in-10” multi-chip could be placed on a number, or column, or line, etc., to indicate that that number, or the numbers in the column, or the numbers straddling a line, etc. will come up 3 times in the next 10 spins. Naturally, virtually any type of multi-event bet based on the layout could be offered using distinct multi-chips identifying particular bet types.

Electronic game 200 includes bet making window 218, which shows various options for making bets, including multiple-event bets. For example, in the example depicted in FIG. 2, multi-chip 206 is placed on the line between numbers 17 and 18 on layout 204. When the multi-chip 206 is placed, bet making window 218 appears and allows the player to customize the bet. In the example depicted in FIG. 2, the bet 218 is based on the occurrence of a 17 or an 18 (i.e. the bet-upon numbers). More specifically, the player has chosen in this example to bet that a 17 or 18 will occur or “hit” five times in the next ten plays. The player has selected these particular bet characteristics (i.e. how many plays and how many hits) in this example by moving the number of plays selector 208 to select ten total plays and moving number of hits selector 210 to select five hits. Based on the player's selection of bet characteristics, the betting window displays the odds 216 of winning the particular bet. Finally, the player selects the bet amount i.e. the stake by using the bet amount selector 212 of bet making window 218.

Notably, bet making window 218 is only a single, exemplary embodiment. Many modifications to the bet making window 218 could be implemented by those of skill in the art. For example, while this example shows a number of plays selector 208 and number of hits selector 210 as sliders, those betting characteristics could also be implemented as text entry fields, drop down fields, button fields, or other graphical data entry fields as are known in the art. The same modifications could be made to the bet amount selector 212. Similarly, bet making window 218 could include additional betting characteristics, such as betting on sequences of numbers, or different combinations of numbers. Bet making window 218 could also include payout or winning fields in addition to the odds field 216.

Electronic roulette game 200 also includes other data fields, such as winnings field 220, which depicts how much a player has won (or lost) with respect to a particular bet; active bets field 222, which depicts how much a player currently has bet or staked on different bets; balance field 224, which depicts how much a player has to play with i.e. the player's bank; active bets field 226, which depicts how many active bets a player has; average odds field 228, which depicts the average odds of the player's one or more active bets; total winnings field 230, which depicts the amount of money a player has won during a particular session, or during more than one sessions (e.g. a lifetime winning count); and potential winnings field 232, which depicts the potential winnings to the player based on all active bets (i.e. if the player wins all the bets). Additionally, other data fields such as player's win percentage and other statistical data fields related to the player's historic (or predicted) performance may be implemented in the graphical user interface of electronic roulette game 200.

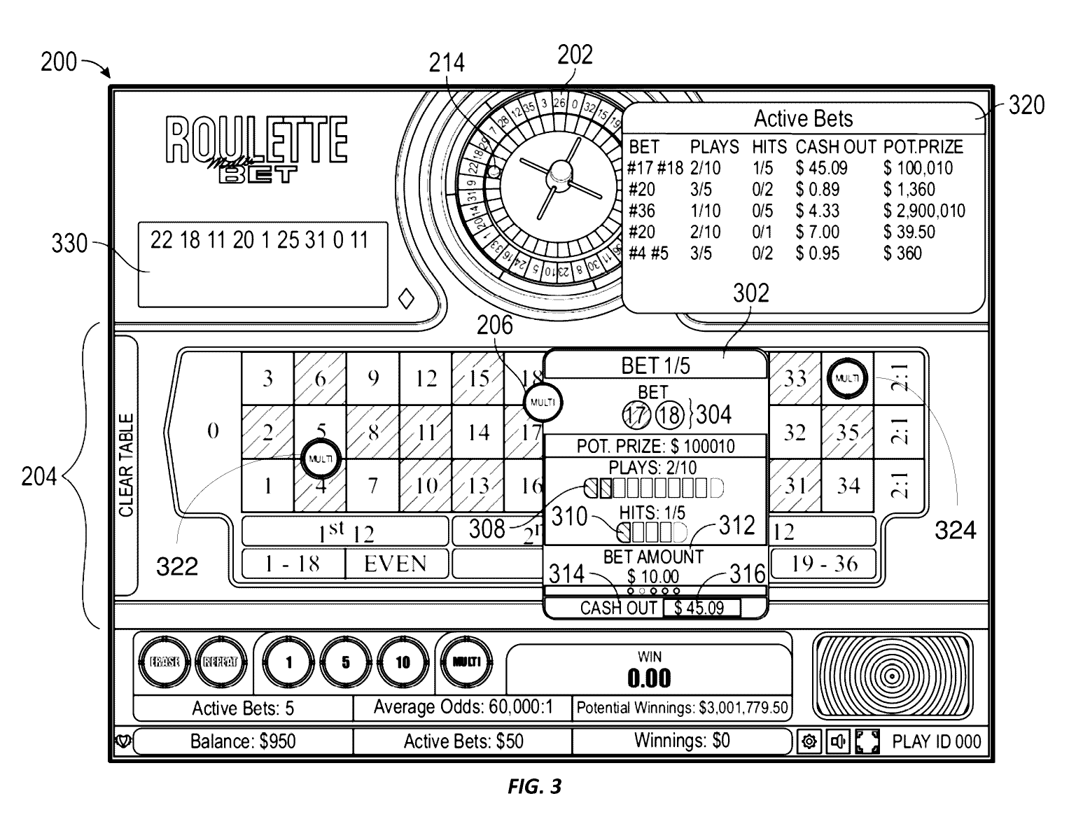

FIG. 3 depicts an electronic roulette game 200 including a multiple-event bet option and a cash-out option. Specifically, while FIG. 2 depicted electronic roulette game 200 during the betting stage, FIG. 3 depicts electronic roulette game 200 during the playing stage. Multi-chip 206 carries over from the FIG. 2. Additional multi-chips 322 and 324 are also depicted and relate to other active multiple-event bets as shown in the active bet monitoring window 320.

FIG. 3 depicts single bet monitoring window 302, which displays information regarding a selected bet 304. Single bet monitoring window 302 includes play counter 308, which depicts the number of plays (i.e. spins) that have been completed during the multiple-event bet. Single bet monitoring window 302 also includes hit counter 310, which depicts the number of successful results or hits related to the currently selected bet 304. That is, for bet 304, the hit counter 310 shows the number of times a 17 or 18 has resulted from a spin or “hit” during the last two plays, as indicated by play counter 308. In this example, hit counter 310 indicates that a 17 or 18 has hit once in the last two plays.

Single bet monitoring window 302 also includes cash-out button 314 and cash-out value field 316. As described above with respect to FIG. 1, the cash-out value changes based on the outcome of events during the multiple-event bet. The cash-out value field 316 displays the current cash-out value based on the events that have transpired during the multiple-event bet and the probabilities associated with the remaining events. In the example depicted in FIG. 3, the cash-out value has increased to $12 based on a bet amount 312 of $10 based on the fact that one positive event (i.e. a hit of 17 or 18) has happened and the player still has eight remaining plays. If, for example, the player decides that a cash-out of $12, which represents a 20% return on the $10 bet 312, is sufficient for his risk tolerance, then the player could select the cash-out button 314 and take the cash-out amount 316 (here $12) in lieu of playing the additional spins.

FIG. 3 also depicts active bet monitoring window 320. In this embodiment, active bet monitoring window 320 includes a “bet” column, which depicts one or more active bets placed by the player. In this instance, the first bet depicted “#17/#18” corresponds to the bet in the single bet monitoring window 302. Active bet monitoring window 320 also includes a “Plays” column, which depicts the number of plays that have already transpired in a particular multiple-event bet. Active bet monitoring window 320 also includes a “Hits” column, which depicts the number of successful results or hits related to the a particular bet. Active bet monitoring window 320 also includes a “Cash Out” column, which depicts current value of the cash-out offer for a particular bet. Finally, active bet monitoring window 320 includes a “Bet Value” column, which depicts the total value of winning a particular bet. Notably, active bet monitoring window 320 is exemplary only, and many modifications to the bet monitoring window 320 could be implemented by those of skill in the art.

FIG. 3 also depicts game result window 330. Game result window 330 shows the results of past plays of the particular game. Here, for example, game result window 330 shows the value of a plurality of prior plays (i.e. spins). Notably, the most recent result “22” is reflected in the game result window 330 and shown by the ball 214 in the “22” pocket of roulette wheel 202. Moreover, the second-most recent result, “18”, is reflected as a hit in single bet monitoring window 302 and active bet window 320.

Active bet monitoring window 320 allows a player to monitor the status of many bets, including single-event and multiple-event bets, and their corresponding characteristics (e.g. plays, hits, winning value, cash-out value, etc.). Further, more than one bet monitoring window, such as window 302, may be displayed at once. Alternatively, bet monitoring windows, such as window 302, may be toggled on and off by, for example, selecting multi-chips, such as multi-chip 206, corresponding to different bets. In some embodiments, whether betting windows are shown is based on the utilization of the display space e.g. so that the display space does not become cluttered or otherwise unattractive to the player.

While FIG. 3 has described and depicted an embodiment of a cash-out feature in the context of an electronic roulette game 200, this description and depiction is exemplary only. Cash-out may be implemented in any multiple-event betting game, such as those betting games described herein. And those betting games including a cash-out option may be implemented by electronic means, or by making physical modifications to physical gaming means, such as physical layouts for various betting games.

Further, while FIGS. 2 and 3 show an electronic roulette game 200 with various “windows” (e.g. bet making window 218, single bet monitoring window 302, active bet monitoring window 320), these particular embodiments are only exemplary. The graphical user interface of electronic roulette game 200 may be modified in different ways such that the player is presented with the same or similar information in different formats. For example, windows that may be toggled in this embodiment may instead be fixed panes or frames in other windows. Likewise, buttons and sliders and the like may be replaced with other graphical user interface elements. In some embodiments, electronic roulette game 200 may be designed to receive touch-screen input from in order to manipulate various game-related elements on the screen. In this way an attractive, dynamic, and functional user interface can be presented to the game player.

In further embodiments, certain aspects described with respect to FIGS. 2 and 3 may be implemented in a physical game of roulette, for example, at a casino. For example, physical roulette table may include displays for players to use to place multiple-event bets, and to monitor multiple-event bets as described above. In such embodiments, a player may interact with both the display (e.g. a touch-screen display) as well as the physical table to place a variety of different types of bets. Such an embodiment would allow a casino to incorporate more advanced types of bets as well as, for example, the cash-out option, without replacing existing tables and layouts.

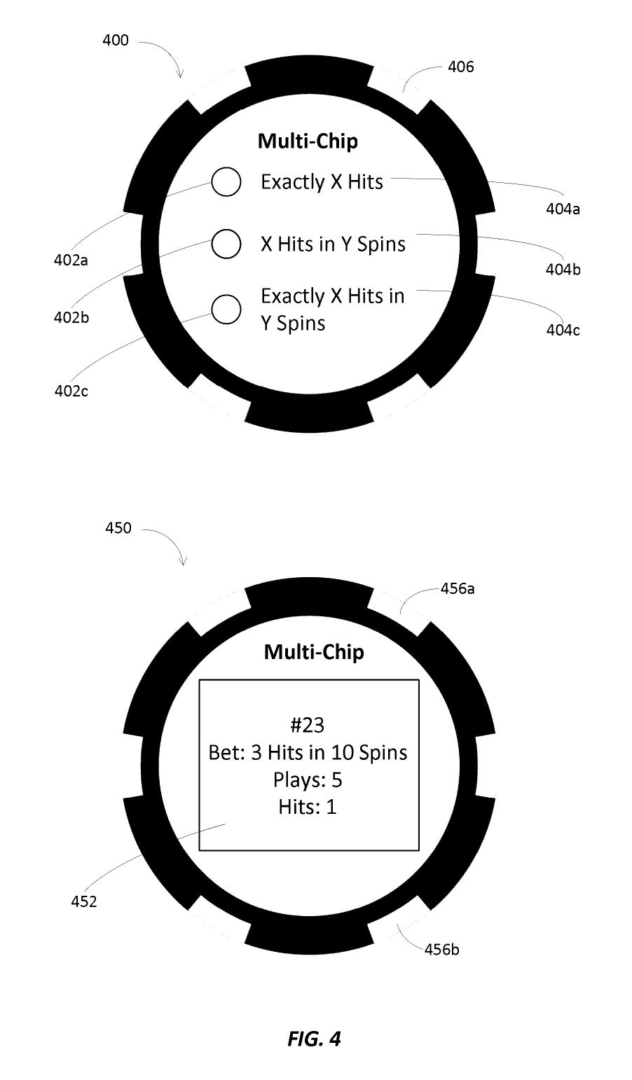

FIG. 4 depicts examples of multi-chips that may be used with multiple-event betting games. In particular, FIG. 4 depicts embodiments of electronic multi-chips to be used with physical roulette games (though the same designs could be implemented in an electronic roulette game).

Multi-chip 400 is an embodiment of a physical multi-chip may include indicators 402a, 402b, and 402c, which may be, for example, LED lights. The indicators 402a, 402b, and 402c correspond to different bets 404a, 404b, and 404c, respectively. Here, those bets, by way of example, are “Exactly X Hits” (i.e. exactly X hits in the next X spins), “X Hits in Y Spins”, and “Exactly X Hits in Y Spins.” These particular bets are exemplary only and any sort of multiple-event bet may be indicated. The multi-chip 400 may reduce the number of physical multi-chips needed at a casino buy offering more than one selectable bet-type per multi-chip. A user input may be used in order to select one of the bets 404a, 404b, and 404c. For example, some portion of multi-chip 400 may be touch-sensitive, or some portion of multi-chip 400 may act as a pressable button, or may include some other user input device as known by those of skill in the art. For example, button 406 may be used to scroll through the various bet selections as indicated by, for example, an illuminated indicator (e.g. an LED light). For example, multi-chip 400 has the “X Hits of Y Spins” bet type selected. In some embodiments, the numbers of hits and spins may be selected by further touch-sensitive areas on the multi-chip 400, or through provision of additional buttons on multi-chip 400.

Multi-chip 450 includes buttons 456a and 456b as well as a display device 452. Display device 452 could be, for example, an LCD display, an e-ink display, a trans-reflective display, or the like. Display device 452 may be used to indicate the type of multiple-event bet being placed. For example, multi-chip 450 currently shows a bet of “3 Hits in 10 Spins” of the number 23.

In some embodiments, multi-chip 450 may include communication circuitry in order to communicate with a complimentary electronic system (not shown) hosted by the game maker. The communication could be by way of, for example, WiFi, Bluetooth, Near Field Communication (NFC) or the like. Such a communication system could, for example, relay to or from the multi-chip 450 data indicating the number of hits and number of plays so that the multi-chip 450 can display the data. For example, here multi-chip 450 indicates that the number 23 has hit once in five plays. Such communication could alleviate the difficulty of the dealer keeping track of various multiple-event bets in addition to the traditional bets being placed on the table.

Additional communication between the multi-chip 450 and the complimentary electronic system could inform the casino of a bet placed by way of the multi-chip 450 using, for example, buttons 456a and 456b.

Notably, multi-chips 400 and 450 are merely exemplary embodiments. These embodiments may be implemented in an electronic game, such as electronic roulette game 200, or they may be implemented in physical chips, such as those used by casinos.

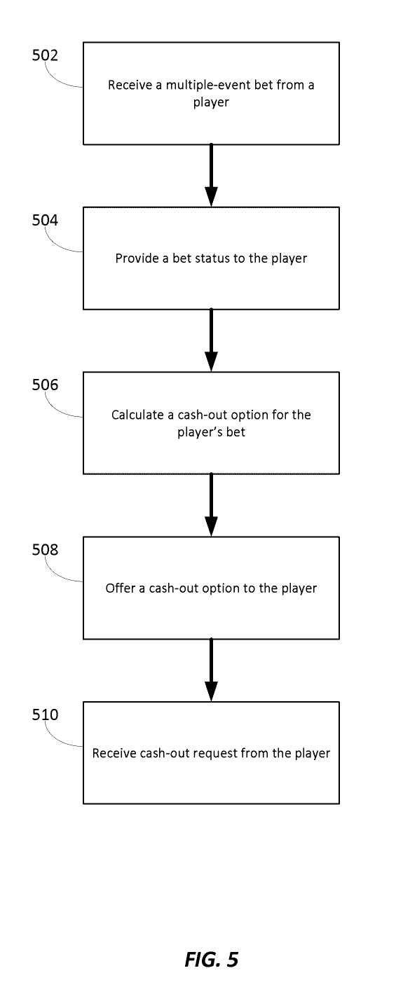

FIG. 5 depicts a method 500 of offering a cash-out option in a multiple-event betting game. The method 500 begins at step 502 where a multiple-event bet is received from a player. For example, as described above, a player could place a multiple-event bet based on a certain number of results (e.g. particular numbers hitting) during a certain number of plays (e.g. spins of the roulette wheel). The multiple-event bet could be received in an electronic (e.g. computer-based) betting game or in a traditional, physical betting game, such as those found at a casino. Receiving the multiple-event bet could be, for example, by detecting a chip placed on a particular portion of a game board, or by entry of bet details into a graphical user interface, or both, as described above with reference to FIG. 2. Detecting the bet can be by electronic, automated means, such as by software interpreting user input for an electronic game, or by a live dealer noting the placement of a bet on a physical table. Other methods of receiving the multiple-event bet are possible as well.

The method then moves to step 504, where a bet status is displayed to a player during the betting game. For example, a display device may include one or more bet status indications or windows or the like to display the status of a player's or multiple players' bets. In some embodiments, such as those describe above, an “Active Bet” window may show one or more active bets being played by a player. In some embodiments, such as an electronic betting game, the display of the bet status may be on the same display as the rest of the game (e.g. all on a computer display or the display of a mobile device). However, in other embodiments, for example in a physical game environment such as a casino, a dedicated display may display bet information to a player while physical game components, such as a physical roulette wheel, may be used by a game maker to determine the outcome of the bet. The bet status may include one or more bet characteristics, such as the number of plays, the number of hits, the type of bet, the odds of the bet, the probability of winning the bet, the payout for the bet, and other as are known in the art.

The method then moves to step 506, where a cash-out option is determined for a player's multiple-event bet. In some embodiments, the cash-out option value may be calculated as described above with respect to FIG. 1. That is, the expected value of a player's multiple-event bet may be updated as events transpire, and a game maker may determine a cash-out offer that maintains a house advantage compared to the expected value given the transpired events. Further, as discussed above, the cash-out determination may be based on additional data, like the stage of the bet, the expected value, the player's past performance or play characteristics, and others.

The method then moves to step 508, where the cash-out option determined in step 506 is offered to the player. The offer may be displayed, for example, on a game screen of an electronic betting game, such as described above with respect to FIG. 3. In other embodiments, the offer may be displayed on a display device that is a part of a physical betting game. For example, as described above, a display device may be used by a player of a physical betting game, such as roulette, in order to place multiple-event bets and monitor their progress, and to select cash-out options offered during the course of the betting game.

The method then moves to step 510, where a cash-out request is received from the player. As described above with respect to FIG. 3, the cash-out option could be received as a result of a player selecting a “cash-out” button in an electronic betting game. Similarly, in physical betting games, such as those found at a casino, a player could interact with a display device or with a game maker, such as a dealer, in order to that the player's cash-out request is received. Upon receiving the cash-out request, the current bet may be terminated and the value of the cash-out paid to the player.

Notably, the method 500 is described with respect to FIG. 5 is exemplary only. One or more steps may be added to or subtracted from the method in different embodiments, and based on different implementations of betting games (both electronic and physical).

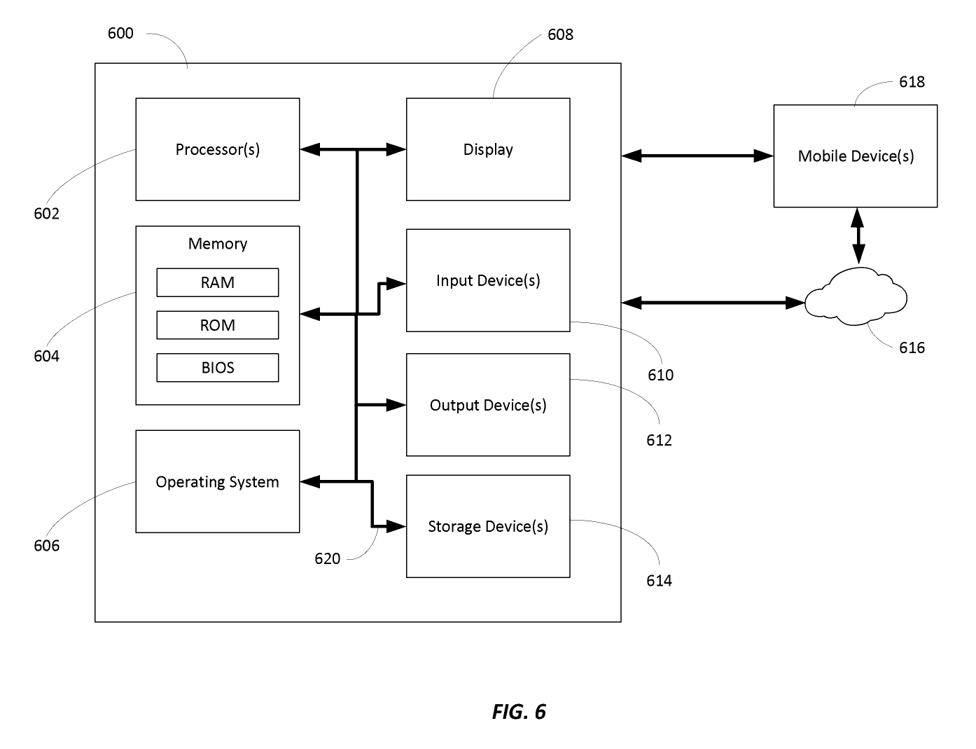

FIG. 6 depicts an example computer system 600, such as may be used to implement electronic betting games, such as electronic roulette game 200 and others. More particularly, an electronic betting game such as electronic roulette game 200 may include software components at one or more computer systems, which may be similar to computer system 600. Particular embodiments may implement various functions of betting games, such as electronic roulette game 200, as hardware, software, or a combination of hardware and software. For example, one or more computer systems may execute particular game logic or game software to perform one or more steps of one or more processes described with respect to the various betting games described herein, including electronic roulette game 200. One or more of the computer systems may be unitary or distributed, spanning multiple computer systems or multiple datacenters, where appropriate. The present disclosure contemplates any suitable computer system.

The components in FIG. 6 are exemplary, and not meant to limit the scope of use or functionality of any hardware, software, embedded logic component, or a combination of two or more such components implementing particular embodiments. Computer system 600 may have any suitable physical form, including but not limited to one or more integrated circuits (ICs), printed circuit boards (PCBs), mobile handheld devices (such as mobile telephones or PDAs or tablet computers), laptop or notebook computers, distributed computer systems, computing grids, or servers. Computer system 600 may include a display 608, one or more input devices 610 (e.g. a keypad, a keyboard, a mouse, a stylus, a touch-sensitive surface, etc.), one or more output devices 612, one or more storage devices 614 (e.g. a database or mass storage device), and various tangible storage media 236.

Data bus 620 connects a wide variety of subsystems. Data bus 620 may comprise one or more analog or digital signal lines. Data bus 620 may be any of several types of bus structures including a memory bus, a peripheral bus, or a local bus using any of a variety of bus architectures. For example, data bus 620 may implement an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, and an Accelerated Graphics Port (AGP) bus.

Processor(s) 602 are coupled to tangible storage devices including memory 604. Memory 604 may include random access memory (RAM) and read-only memory (ROM) 205. The ROM may act to communicate data and instructions uni-directionally to processor(s) 602, and the RAM may act to communicate data and instructions bi-directionally with processor(s) 602. The ROM and RAM may include any suitable tangible computer-readable media described below.

Storage device(s) 614 is connected bi-directionally to processor(s) 601 and provide additional data storage capacity and may also include any suitable tangible computer-readable media described. Storage device(s) 614 may be used to store operating system 606, application programs, and the like.

Processor(s) 602 is connected to multiple interfaces that are in turn connected to appropriate devices, such as display 608, input devices 610, output devices 612, storage devices 614, and memory 604. In general, an input/output (I/O) device may be a video display, a track ball, a mouse, a keyboard, a microphone, a touch-sensitive display, a transducer card reader, a magnetic- or paper-tape reader, a tablet, a stylus, a voice or handwriting recognizer, a biometrics reader, another computer system, or other suitable I/O device or a combination of two or more such I/O devices. Processor(s) 602 may connect to another computer system, such as mobile device 618, or to a network 616 through a network interface (not shown). By way of the network interface, Processor(s) 602 may communicate with network 616 and devices connected thereto (e.g. mobile device 618) in the course of performing one or more steps of one or more processes described or depicted herein. Moreover, one or more steps of one or more processes described or depicted herein may execute solely at processor 602. Alternatively, one or more steps of one or more processes described or depicted herein may execute at multiple processors 602 that are remote from each other across network 230.

In particular embodiments, when computer system 600 is connected to network 616, computer system 500 may communicate with other devices, specifically mobile devices 618 and other electronic systems connected to network 616. Communications to and from computer system 600 may be sent through a network interface. For example, a network interface may receive incoming communications (such as requests or responses from other devices) in the form of one or more packets (such as Internet Protocol (IP) packets) from network 616 and computer system 600 may store the incoming communications in memory 604 for processing. Computer system 600 may similarly store outgoing communications (such as requests or responses to other devices) in the form of one or more packets in memory 604 and communicated to network 616 from a network interface. Processor(s) 602 may access these communication packets stored in memory 604 for processing.

Computer system 600 may provide functionality as a result of processor(s) 602 executing software embodied in one or more tangible computer-readable storage media, such as memory 604, storage device 614, or the like. The computer-readable media may store software that implements particular embodiments, and processor(s) 602 may execute the software. Memory 604 may read the software from one or more other computer-readable media or from one or more other sources through a suitable interface, such as a network interface or a data bus 620. The software may cause processor(s) 602 to carry out one or more processes or one or more steps of one or more processes described or illustrated herein. Carrying out such processes or steps may include defining data structures stored in memory 604 and modifying the data structures as directed by the software. In addition or as an alternative, computer system 600 may provide functionality as a result of logic hardwired or otherwise embodied in a circuit, which may operate in place of or together with software to execute one or more processes or one or more steps of one or more processes depicted or illustrated herein.

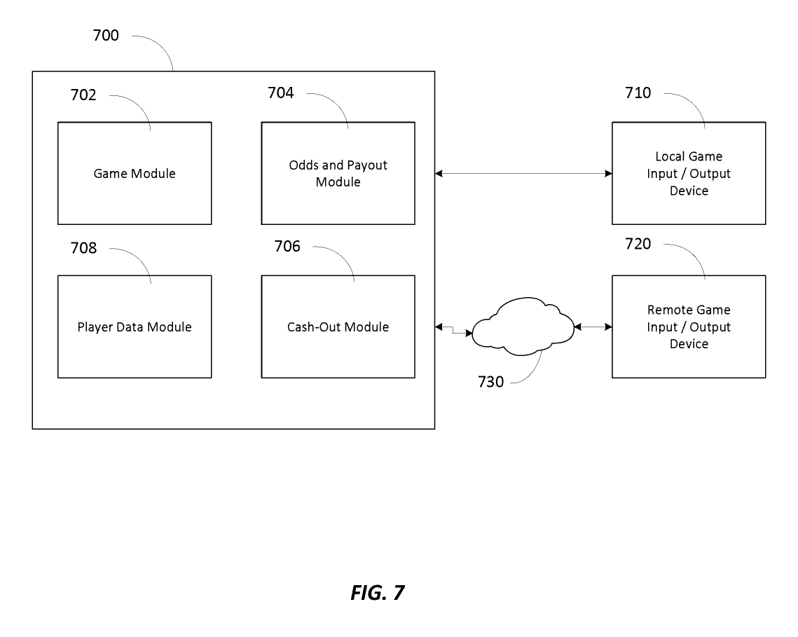

FIG. 7 depicts an electronic betting game system 700, including a game module 702, odds and payout module 704, player data module 706, and cash-out module 708.

The game module 702 may include hardware and software configured to implement one or more betting games, such as roulette, craps, or the like. For example, the game module 702 may include data for game screens, game rules, game sounds, and the like. The game module may be implemented for completely electronic betting games, or may be implemented to supplement physical betting games at casinos. For example, the game module may generate data for output on display devices related to physical games, such as the spin tracker display in roulette, or the current jackpot for slots, and the like.

The odds and payout module 704 may include hardware and software configured to calculate odds and probabilities for one or more games implemented by the game module 702. For example, the odds and payout module 704 may be configured to calculate odds for winning a variety of single- and multiple-event bets in different betting games. Additionally, the odds and payout module 704 may be configured to determine payouts for a variety of single- and multiple-event bets in different games. The odds and payout module 704 may be further configured to set and maintain a house advantage for a variety of betting games.

The cash-out module 706 may include hardware and software configured to calculate cash-out options for one or more games implemented by the game module 702. For example, the cash-out module 706 may be configured to implement different cash-out advantages, including flat discount rates, graduated discount rates based on payouts, and player-specific discount rates based on player-specific behavior. The cash-out calculator module may be further configured to offer a cash-out option to a player, and to receive a cash-out request from a player.

The player data module 708 may include hardware and software configured to receive, analyze, and make determinations based on player-specific gaming data. In some embodiments, the cash-out module 706 may configure player-specific cash-out options based on player-specific gaming data analyzed by the player data module 708.

Electronic betting game system 700 may receive data from and send data to various local input and output devices 710. For example, a roulette game at a casino may be supplemented with touch-screen input devices for receiving multiple-event bets as well as receiving cash-out requests. The same device may also be an output device that allows the casino to offer cash-out options and to display various game data. In another example, an electronic slots game at a casino may be supplemented with a touch-screen input device for receiving multiple-event bets as well as receiving cash-out requests. And again, the touch-screen device may also be an output device for offering cash-out options. Notably, input and output devices are not limited to touch-screen devices and may instead be any sort of input device as are known by those of skill in the art.

Electronic betting game system 700 may receive data from and send data to various remote input and output devices 720 via, for example, a network 730, such as the internet. For example, a betting game may be implemented through a website and a player may interact with the game through any device capable of accessing the website. Such devices may include desktop computers, mobile computers, tablet computers, smartphones, and the like. As such, a game like roulette may be implemented by electronic betting game system 700 so that a remote player may play the game, including placing multiple-event bets and receiving and requesting cash-out options, over the internet using a wide variety of electronic devices.

Notably, the description of electronic betting game system 700 including separate modules is exemplary only. In other embodiments, one or more of the modules may be combined. For example, the game module 702 may be combined with the odds and payout module 704. In yet other embodiments, all of the modules may be combined in order to create a game-specific module for electronic betting game system 700.

Reference to software in the present disclosure may encompass one or more computer programs that may encompass data, instructions, or both.

One or more tangible and non-transitory computer-readable media may store or otherwise embody software implementing particular embodiments. A tangible computer-readable medium may be any tangible medium capable of carrying, communicating, containing, holding, maintaining, propagating, retaining, storing, transmitting, transporting, or otherwise embodying software, where appropriate. A tangible computer-readable medium may be a biological, chemical, electronic, electromagnetic, infrared, magnetic, optical, quantum, or other suitable medium or a combination of two or more such media, where appropriate. Example tangible, non-transitory computer-readable media include, but are not limited to, application-specific integrated circuits (ASICs), compact discs (CDs), field-programmable gate arrays (FPGAs), floppy disks, floptical disks, hard disks, holographic storage devices, magnetic tape, caches, programmable logic devices (PLDs), random-access memory (RAM) devices, read-only memory (ROM) devices, semiconductor memory devices, and other suitable computer-readable media.

Software implementing particular embodiments may be written in any suitable programming language (which may be procedural or object oriented) or combination of programming languages, where appropriate. Any suitable type of computer system (such as a single- or multiple-processor computer system) or systems may execute software implementing particular embodiments, where appropriate. A general-purpose or specific-purpose computer system may execute software implementing particular embodiments, where appropriate.

What is claimed is:

1. An electronic game system for a betting game, comprising:
an electronic data store comprising computer-executable software;
one or more processors configured to execute the software and cause the electronic game system to:
receive a first input associated with a multiple-event bet from a game player;
determine a number of hits associated with the multiple-event bet;
determine a number of plays associated with the multiple-event bet, wherein the determined number of hits is less than the determined number of plays;
determine a bet amount associated with the multiple-event bet;
determine a multiple-event payout based, at least in part, on the determined bet amount and a determined likelihood of the determined number of hits occurring over the determined number of plays;
after determining a first game result of the determined number of plays, but before determining a last game result of the determined number of plays, determine whether the determined number of hits occurring over the determined number of plays is still possible;
when it is determined that the determined number of hits occurring over the determined number of plays is still possible, determine a cash-out payout offer and cause the cash-out payout offer to be displayed to the player, wherein the cash-out payout offer is less than the determined multiple-event payout; and
when a second input is received indicating an acceptance of the offered cash-out payout from the game player, provide the cash-out payout to the game player and terminate the multiple-event bet.

2. The electronic game system of claim 1, further comprising:
a display device; and
wherein the one or more processors are further configured to cause the electronic game system to cause the display device to:
display a number of hits selector;
display a number of plays selector;
display a bet amount selector; and
display a payout field, wherein the payout field displays a potential payout based on a current indication by the number of hits selector, a current indication by the number of plays selector, and a current indication by the bet amount selector.

3. The electronic game system of claim 2, wherein the one or more processors are further configured to cause the electronic game system to:
receive a hits input via the number of hits selector;
receive a number of plays input via the number of plays selector;
receive a bet amount input via the bet amount selector; and
associate the hits input, the number of plays input, and the bet amount input with the multiple-event bet.

4. The electronic game system of claim 1, further comprising:
a display device; and
wherein the one or more processors are further configured to cause the electronic game system to cause the display device to:
display a play counter;
display a hit counter;
display a cash-out button; and
display a cash-out value field, wherein the cash-out value field displays the cash-out payout offer.

5. The electronic game system of claim 1, wherein the cash-out payout offer is additionally based on game player data.

6. The electronic game system of claim 1, wherein the one or more processors are further configured to cause the electronic game system to: when the determined number of hits occurs within the determined number of plays, provide the multiple-event payout to the player and terminate the multiple-event bet.

7. The electronic game system of claim 1, wherein the one or more processors are further configured to cause the electronic game system to: associate the first game result with a plurality of different multiple-event bets from the game player.

8. An electronic game system, comprising:
a display device;
an electronic data store comprising computer-executable instructions;
at least one processor configured to execute the instructions and cause the electronic game system to:
receive an input associated with a multiple-event bet from a player;
determine a number of particular events associated with the multiple-event bet, wherein the determined number of particular events is greater than one;
determine a number of game events associated with the multiple-event bet, wherein the determined number of game events is greater than the determined number of particular events;
determine a multiple-event payout based, at least in part, on the multiple-event bet, the determined number of particular events, and the determined number of game events;
cause the display device to display the determined multiple-event payout;
determine a first game event of the determined number of game events;
adjust a hit counter when the first game event is a successful result;
after determining the first game event, but before determining a last game event of the determined number of game events, cause a cash-out payout offer to be displayed on the display device, wherein the cash-out payout offer is less than the determined multiple-event payout; and
when a cash-out input is received indicating an acceptance of the displayed cash-out payout offer from the game player, provide the cash-out payout to the player and terminate the multiple-event bet.

9. The electronic game system of claim 8, wherein the at least one processor is further configured to cause the electronic game system to cause the display device to:
display a number of hits selector;
display a number of plays selector;
display a bet amount selector; and
display a payout field, wherein the payout field displays a potential payout based on a current indication by the number of hits selector, a current indication by the number of plays selector, and a current indication by the bet amount selector.

10. The electronic game system of claim 9, wherein the one or more processors are further configured to cause the electronic game system to:
receive a particular events input via the number of hits selector;
receive a set number of game events input via the number of plays selector;
receive a bet amount input via the bet amount selector; and
associate the particular events input, the set number of game events input, and the bet amount input with the multiple-event bet.

11. The electronic game system of claim 8, wherein the at least one processor is further configured to cause the electronic game system to cause the display device to:
display a play counter;
display the hit counter;
display a cash-out button; and
display a cash-out value field, wherein the cash-out value field displays the cash-out payout offer.

12. The electronic game system of claim 8, wherein the cash-out payout offer is additionally based on player data.

13. The electronic game system of claim 8, wherein the at least one processor is further configured to cause the electronic game system to: provide the multiple-event payout to the player when the hit counter indicates a predetermined number of successful results has occurred, and terminate the multiple-event bet.

14. The electronic game system of claim 8, wherein the at least one processor is further configured to cause the electronic game system to: associate the first game event with a plurality of different multiple-event bets from the player.

15. A method of operating a gaming system, the method comprising:
receiving an electronic indication of a multiple-event bet from a game player;
causing at least one processor to execute a plurality of computer-executable instructions to determine a number of particular events associated with the multiple-event bet, wherein the determined number of particular events is greater than one;
causing the at least one processor to execute the plurality of computer-executable instructions to determine a number of game events associated with the multiple-event bet, wherein the determined number of game events is greater than the determined number of particular events;
causing the at least one processor to execute the plurality of computer-executable instructions to determine a multiple-event payout based, at least in part, on the multiple-event bet, the determined number of particular events, and the determined number of game events;
causing the at least one processor to execute the plurality of computer-executable instructions to cause a display device to display the determined multiple-event payout;
causing the at least one processor to execute the plurality of computer-executable instructions to determine a first game event of the determined number of game events;
causing the at least one processor to execute the plurality of computer-executable instructions to adjust a hit counter if the first game event is a successful result;
causing the at least one processor to execute the plurality of computer-executable instructions to, after determining the first game event, but before determining a last game event of the determined number of game events, cause a cash-out payout offer to be displayed on the display device, wherein the cash-out payout offer is less than the determined multiple-event payout; and
causing the at least one processor to execute the plurality of computer-executable instructions to, when a cash-out input is received indicating an acceptance of the determined cash-out payout offer from the game player, provide the cash-out payout to the player and terminate the multiple-event bet.

16. The method of claim 15, which includes causing the at least one processor to execute the plurality of computer-executable instructions to cause the display device to:
display a number of hits selector;
display a number of plays selector;
display a bet amount selector; and
display a payout field, wherein the payout field displays a potential payout based on a current indication by the number of hits selector, a current indication by the number of plays selector, and a current indication by the bet amount selector.

17. The method of claim 16, which includes causing the at least one processor to execute the plurality of computer-executable instructions to:
receive a particular events input via the number of hits selector;
receive a set number of game events input via the number of plays selector;
receive a bet amount input via the bet amount selector; and
associate the particular events input, the set number of game events input, and the bet amount input with the multiple-event bet.

18. The method of claim 15, which includes causing the at least one processor to execute the plurality of computer-executable instructions to cause the display device to:
display a play counter;
display the hit counter;
display a cash-out button; and
display a cash-out value field, wherein the cash-out value field displays the cash-out payout offer.

19. The method of claim 15, which includes causing the at least one processor to execute the plurality of computer-executable instructions to cause the display device to: provide the multiple-event payout to the player when the hit counter indicates a predetermined number of successful results has occurred, and terminate the multiple-event bet.

20. The method of claim 15, which includes causing the at least one processor to execute the plurality of computer-executable instructions to associate the first game event with a plurality of different multiple-event bets from the player.
